(19) United States
(12) Patent Application Publication
(10) Pub. No.: US 2011/0308335 A1
(43) Pub. Date: Dec. 22, 2011

(54) Sample Tube with Identification

(75) Inventors: Rosa Pink, Leuzigen (CH); Martin Berger, Muri (CH)

(73) Assignee: NEXUS BIOSYSTEMS, INC., Poway, CA (US)

(21) Appl. No.: 13/061,083

(22) PCT Filed: Aug. 11, 2009
(86) PCT No.: PCT/EP09/60392

§ 371 Date: May 16, 2011

(30) Foreign Application Priority Data
Aug. 25, 2008 (CH) 01348/08

(51) Int. Cl. B01L 3/14

(52) U.S. Cl. 73/864.91

(57) ABSTRACT

A sample tube (1) is provided with a top opening (2) that is surrounded by side walls (3) which merge into a bottom (4), the bottom (4) of the sample tube (1) comprising an essentially flat downside (5) that is arranged farther to the top opening (2), wherein the sample tube comprises an identification portion (6) located at the bottom side of the sample tube (1). The sample tube (1) according to the present invention is characterized in that the identification portion (6) is composed of an opaque material (7) with a first color and a transparent cover layer (8), wherein the transparent cover layer (8) comprises a laser sensitive filler that, upon irradiation with a laser marking beam, turns an irradiated area (9) of the transparent cover layer (8) into an opaque area with a second color that is contrasting from the first color.

According to the preamble of the independent claim 1, the invention relates to a sample tube with a top opening that is surrounded by side walls which merge into a bottom. The bottom of the sample tube comprises an essentially flat downside that is arranged farther to the top opening. The sample tube comprises an identification portion that is located at the bottom side of the sample tube.

Sample tubes for storage and transport of liquid samples are well known in e.g. laboratories that apply liquid handling techniques in biochemical and biological research or in clinical diagnosis. Whereas larger sample tubes can contain up to several milliliters of e.g. blood or other body fluids, smaller sample tubes are known as microtubes that may only contain some microliters of a liquid or a solid sample. Microtubes that can be stored in racks, which are of the size of a standard microplate (see ANSI/SBS standard 1-2004) are known form the prior art. There are racks of this format known for 96 microtubes (e.g. from EP 1 361 441 A1) as well as for 384 microtubes (e.g. EP 0 904 841 A2).

Especially for automatic transportation, storage, retrieval, and tracking of such sample tubes in complex laboratory environments, individual identification of the sample tubes is required. This is especially the case in clinical diagnosis laboratories where clear identification of each sample is a must.

From EP 1 210 979 B1 a sample tube is known which comprises a printed identification tag inside a fluid-tight bottom cap or within a gap in-between double side walls of the sample tube.

From JP 2004-053 566, a cylindrical mini-tube is known with a shallow cylindrical recessed part on the bottom face. The recessed part comprising a 2-D bar code on its ceiling face with information on the content stored in the mini-tube. The recessed part comprises a transparent protective board of a synthetic resin or the like to protect the recording face with the bar code in a water-tight fashion.

From JP 2006-232 292, a container with electronic tag and radio frequency identification (RFID) system is known. The electronic RFID tag preferably is fixed in approximately horizontal orientation to the bottom inside of the container. In order to protect the RFID tag from fluids in the container, a protective member having a recession is sealingly positioned over the tag. Another arrangement is known from JP 2006-168 757, where the RFID tag is situated in a recess on the downside of the bottom of a glass container; the RFID being sealingly covered by a glass plate that covers the recess.

Another approach is known from U.S. Pat. No. 6,372,293 B1, which discloses a tubular container with an open top of unitary construction that includes an enclosed side wall and an integral bottom. On the planar exterior surface of the bottom, machine readable data are encoded within a multilayered opaque coating that is deposited onto the surface of the bottom. The machine readable code is formed in the multilayered coating by removing portions of the second layer.

Again another approach is known from U.S. Pat. No. 6,270,728 B1, which discloses a test tube with a dot code on the surface thereof. The dot code, which is burned into the surface of the bottom of the test tube with a laser, is readable with an optical reading mechanism.

It is the object of the present invention to propose an alternative sample tube with an identification portion that is located at the bottom side.

This object is achieved by the features of the independent claim 1 in that a sample tube with a top opening that is surrounded by side walls which merge into a bottom is proposed. The bottom of the sample tube comprises an essentially flat downside that is arranged farther to the top opening, wherein the sample tube comprises an identification portion located at its bottom side. The alternative sample tube according to the present invention is characterized in that the identification portion is composed of an opaque material with a first color and a transparent cover layer, wherein the transparent cover layer comprises a laser sensitive filler that, upon irradiation with a laser marking beam, turns an irradiated area of the transparent cover layer into an opaque area with a second color that is contrasting from the first color.

Additional preferred embodiments and inventive features derive from the dependent claims.

The sample tube according to the present invention is now described in more detail with the help of the attached, schematic drawings that show preferred exemplary embodiments without restricting the scope of the present invention. It is shown in:

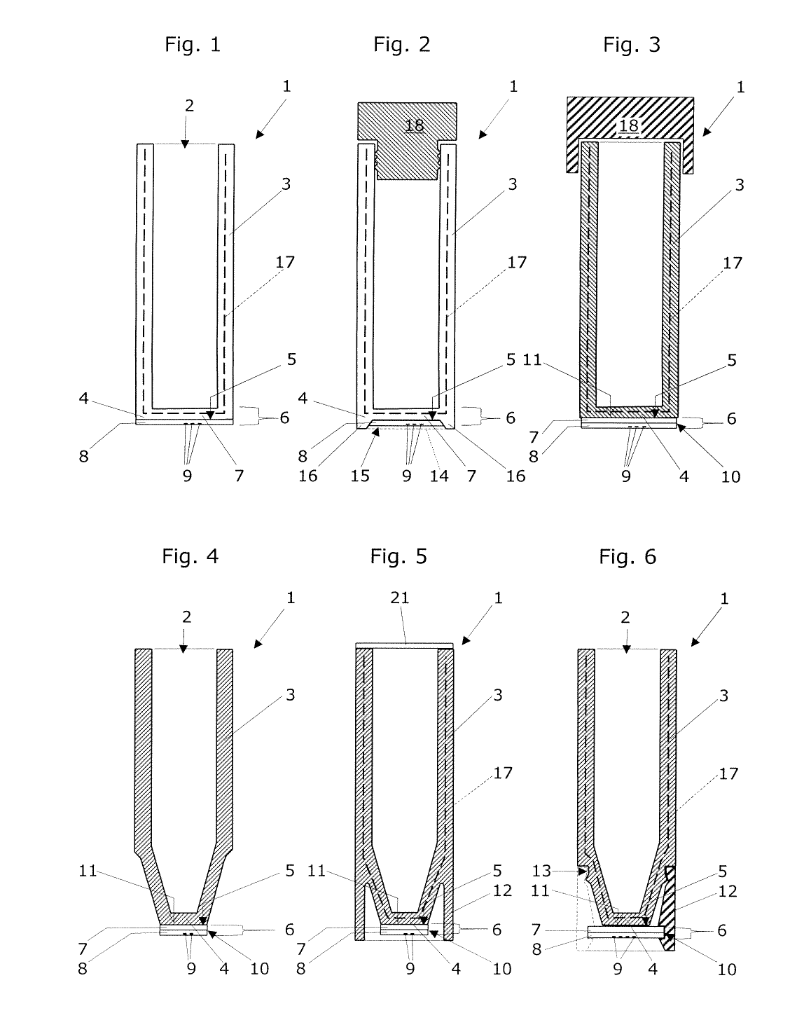

FIG. 1 a longitudinal section of a sample tube with a flat, two-part bottom structure and integrated identification according to a first embodiment;

FIG. 2 a longitudinal section of a sample tube with a recessed, two-part bottom structure and integrated identification according to a second embodiment;

FIG. 3 a longitudinal section of a sample tube with a flat, three-part bottom structure and integrated identification according to a third embodiment;

FIG. 4 a longitudinal section of a sample tube with a narrowed, three-part bottom portion and integrated identification according to a fourth embodiment;

FIG. 5 a longitudinal section of a sample tube with a narrowed, three-part bottom portion, integrated carrier walls, and integrated identification according to a fifth embodiment;

FIG. 6 a longitudinal section of a sample tube with a narrowed, three-part bottom portion, snap-on carrier walls and identification according to a sixth embodiment;

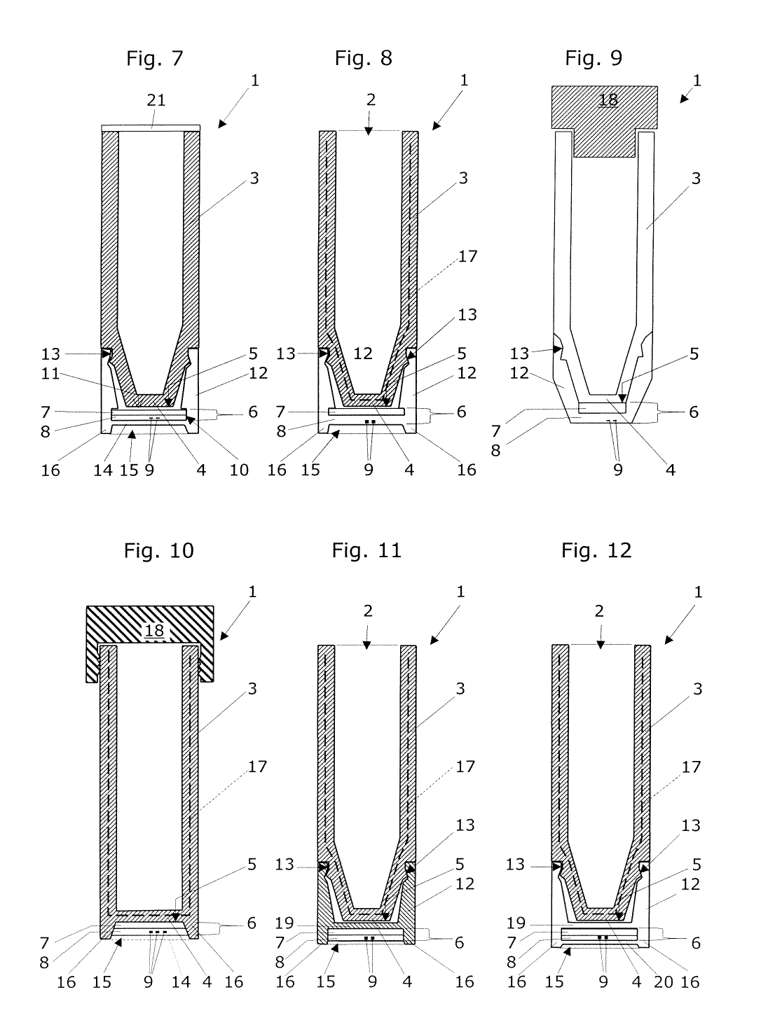

FIG. 7 a longitudinal section of a sample tube with a narrowed, four-part bottom portion, snap-on carrier walls and identification with a protective layer according to a seventh embodiment;

FIG. 8 a longitudinal section of a sample tube with a narrowed, three-part bottom portion, snap-on carrier walls with an RFID tag and identification according to an eighth embodiment;

FIG. 9 a longitudinal section of a sample tube with a narrowed, three-part bottom portion, molded-on carrier walls with an RFID tag and identification according to a ninth embodiment;

FIG. 10 a longitudinal section of a sample tube with a flat, three-part bottom structure and integrated identification according to a tenth embodiment;

FIG. 11 a longitudinal section of a sample tube with a narrowed, four-part bottom portion, snap-on carrier walls with an RFID tag and identification according to an eleventh embodiment;

FIG. 12 a longitudinal section of a sample tube with a narrowed, five-part bottom portion, snap-on carrier walls with an RFID tag and identification according to a twelfth embodiment.

The FIG. 1 shows a longitudinal section of a sample tube with a flat, two-part bottom structure and integrated identification according to a first embodiment of the invention. The sample tube 1 has a top opening 2 that is surrounded by side walls 3. These side walls preferably form a cylindrical tube and merge into a bottom 4. Deviating from this FIG. 1, the sample tube 1 could also have an ellipsoidal or polyhedral cross section (not shown). The thickness of the side walls 3 considerably depends on the planned volume of the tube that typically ranges from 40 μl to 900 μl. A typical wall thickness is in the range of 0.3 mm to 2 mm and preferably ranges from 0.5 mm to 1 mm. The bottom 4 of the sample tube 1 comprises an essentially flat downside 5 that is arranged farther to the top opening 2. A typical bottom thickness is in the range of 0.2 mm to 1.2 mm and preferably ranges from 0.3 mm to 1 mm.

In addition, the sample tube 1 comprises an identification portion 6 that is located at the bottom side of the sample tube 1. According to the present invention, the identification portion 6 is composed of an opaque material 7 with a first color and a transparent cover layer 8. The transparent cover layer 8 comprises a laser sensitive filler that, upon irradiation with a laser marking beam, turns an irradiated area 9 of the transparent cover layer 8 into an opaque area with a second color that is contrasting from the first color. A typical transparent cover layer thickness is in the range of 0.2 mm to 1.0 mm and preferably ranges from 0.3 mm to 0.5 mm.

In the concept of the present invention, the expression “opaque” describes the ability of the material to block a considerable amount, i.e. at least 60%, preferably more than 75%, and especially preferred more than 90%, of a laser scanning light as emitted by a bar code reader from penetrating this material. In the concept of the present invention, the expression “transparent” describes the ability of the material to let a considerable amount, i.e. at least 60%, preferably more than 75%, and especially preferred more than 90%, of a laser canning light as emitted by a bar code reader passing through this material. In the concept of the present invention, the expression “filler” describes additives that preferably are equally dispersed within the plastic material of the respective parts of a sample tube 1 as specified below.

In a sample tube 1 according to the invention, is particularly preferred that the irradiated area 9 is part of an identification marking which is selected from a group that comprises a linear 1-D barcode, a circular 1-D barcode, and a 2-D barcode.

FIG. 1 depicts a sample tube 1, of which the opaque material 7 of the identification portion 6 is the same material as for the side walls 3 and the bottom 4 of the sample tube 1. This opaque material 7 preferably exhibits a white or milky white first color. This sample tube with its side walls 2 and bottom 4 preferably is accomplished as an integral injection molded body of polypropylene (preferably PURELL HP371P, a polypropylene homo-polymer of LyondellBasell Industries, Rotterdam, The Netherlands) and it is preferred to color this sample tube 1 by adding an amount of 1 to 10 wt % of a white colorant, e.g. TiO₂ to the polypropylene prior to injection molding.

The preferred material for the transparent cover layer 8 again is polypropylene, wherein the material PURELL HP371P nature is especially preferred. As a laser sensitive filler, HP756197 LS (MAXITHEN® from GABRIEL-CHEMIE, Gumpoldskirchen, Austria) in an amount of about 0.5 to 5 wt % preferably is added to the polypropylene. This laser sensitive filler, upon irradiation with a laser marking beam, turns an irradiated area 9 of the transparent cover layer 8 into a dark grey or black opaque area that is well contrasting from the first color and that is easy to recognize with a conventional bar code reader. Other laser sensitive fillers (e.g. Iriodin® or Lazerflair®, which is available in seven color variants from MERCK KGaA, Darmstadt, Germany) may be chosen that also provide good contrasted irradiated areas 9, but that result in dark grey, dark red, dark blue, or dark green colored irradiated areas 9. The transparent cover layer 8 may be back-molded onto the bottom 4 of the sample tube 1, or the sample tube 1 may be back-molded onto the transparent cover layer 8. As a further possibility of producing large numbers of this sample tube 1 with a flat bottom according to the first embodiment, multi-component injection molding can be applied as well, one component being the sample tube 1 with side walls 3 and bottom 4, and another component being the transparent cover layer 8.

The FIG. 2 shows a longitudinal section of a sample tube with a recessed, two-part bottom structure and integrated identification according to a second embodiment of the invention. The materials and dimensions preferably are the same as specified with respect to the FIG. 1. The second embodiment, however, comprises protective bars 16 that are located in the periphery of the bottom 4 and that protrude over the lower surface of the transparent cover layer 8. These protective bars can be accomplished as a closed ring structure or as a number of bars that are separated by depressions (not shown). In ay case, these protective bar or bars provide the transparent cover layer 8 with a protection against scratches in its surface. As an alternative protection of the surface of the transparent cover layer 8, the recess 15 between the protective bars 16 can be filled (e.g. by over-molding) with a transparent protective layer 14 (see dashed line in FIG. 2) of polypropylene, preferably PURELL HP371P nature. In addition, the sample tubes of the present invention can be sealed with cap 18 that is screwed-on or pushed-on, screwed-in (as shown) or pushed-in.

In this second embodiment, a two component bottom structure is shown. This bottom structure comprises the bottom 4 (as the opaque material 7) and the transparent layer 8. Thus, the identification portion 6 is formed from the bottom 4 of the sample tube 1 and the transparent layer 8.

The FIG. 3 shows a longitudinal section of a sample tube with a flat, three-part bottom structure and integrated identification according to a third embodiment of the invention. This sample tube 1 is characterized in that the opaque material 7 of the identification portion 6 is a different material as for the side walls 3 and the bottom 4 of the sample tube 1. In consequence and deviating from the first two embodiments already described, the preferred material for the side walls 3 and the bottom 4 is a transparent polymer material, like PURELL HP371P nature. The dimensions of this sample tube 1 with its side walls 2 and bottom 4, which preferably is accomplished as an integral injection molded body of polypropylene, preferably are the same as specified with respect to the FIG. 1.

Similar to the previous embodiments, the opaque material 7 of this sample tube 1 exhibits a first bright color. Now however, the first color is selected from a group that comprises white, milky white, bright grey, bright red, bright blue, bright green, bright yellow, and bright orange, wherein the second color again is a dark color selected from a group comprising grey, red, blue, green and black. The opaque material 7 preferably is polypropylene (preferably PURELL HP371P) and it is preferred to color this opaque material 7 by adding an amount of 1 to 10 wt % of a white colorant, e.g. TiO₂ to the polypropylene. The preferred material for the transparent cover layer 8 again is polypropylene, wherein the material PURELL HP371P nature is especially preferred. As a laser sensitive filler also here, HP756197 LS (MAXITHEN® from GABRIEL-CHEMIE, Gumpoldskirchen, Austria) in an amount of about 0.5 to 5 wt % preferably is added to the polypropylene. It is also feasible that the opaque material 7 of the sample tube 1 is dark gray or black (which may be achieved by a carbon black filler) and that the transparent cover layer 8 comprises a special laser sensitive filler (e.g. white Lazerflair® 810 from MERCK KGaA, Darmstadt, Germany) that is changing into bright or white spots when irradiating the transparent cover layer 8 with a marking laser.

Actually, the opaque material 7 of the identification portion 6 and the transparent cover layer 8 with the filler together form a two-component plastic sheet 10, which may be produced by multi-component injection molding, laminating or back-molding. This two-component plastic sheet 10 preferably is attached (e.g. glued or welded) to the bottom 4 of the sample tube 1. In an alternative production process, the side walls 2 and the bottom 4 of the sample tube 1 are back-molded (preferably PURELL HP 371 P nature) to a rear side 11 of the opaque material 7 of the two-component plastic sheet 10.

In addition to the already described features of the sample tube 1 according to one of the embodiments 1-3, the side walls 3 and the bottom 4 of the sample tube 1 comprise different plastic components including one that provides the sample tube 1 with an enhanced fluid barrier. Actually, the side walls 3 and the bottom 4 comprise two layers of polypropylene (PURELL HP371P nature or PURELL HP371P colored with 1-10 wt % white colorant; e.g. TiO₂) and an intermediate polyamide barrier layer 17 in-between. The purpose of the fluid barrier layer or intermediate fluid barrier layer 17 is to block or at least considerably reduce diffusion of water molecules into or out of the tube 1 and of gas molecules (such as O₂, N₂, CO₂, or O₃) into or out of the tube 1. Accordingly, fluids are herein understood as liquids, gases or liquid/gas mixtures. Especially during long term storage and transportation, gases such as O₂ or O₃ can penetrate the sample tube 1 or microtube walls and may have a destructive effect to the chemical or biological sample stored with in the tube. On the other hand, a loss of water can dehydrate and thus damage a sample as well. Enhancing the diffusion barrier in sample tubes 1 and tight capping or sealing of these tubes therefore is targeted.

The intermediate polyamide barrier layer 17 preferably is made of a crystalline polyamide resin. Especially preferred is an intermediate polyamide barrier layer 17 that is made of nylon-MXD6, which is one of the crystalline polyamide resins that is produced through polycondensation of metaxylylene diamine (MXDA) with adipic acid by MITSUBISH GAS CHEMICAL CO. INC (Tokyo, Japan). The preferred maximum thickness of this intermediate polyamide barrier layer 17 is 40 μm.

Another preferred intermediate polyamide barrier layer 17 is made of an amorphous nylon copolymer. Especially preferred is an intermediate polyamide barrier layer 17 that is made of nylon 6I/6T, which is known as the polyamide copolymer GRIVORY® G21 produced by EMS-GRIVORY (Domat/Ems, Switzerland). The preferred thickness of this intermediate polyamide barrier layer 17 is 100-300 μm.

It goes without saying that all sample tubes 1 of the present invention can be equipped with such an intermediate polyamide barrier layer 17 that preferably is produced by co-extrusion with the sample tube side walls 3 and bottom 4.

FIG. 4 shows a longitudinal section of a sample tube with a narrowed, three-part bottom portion and integrated identification according to a fourth embodiment. All what has bee said about the third embodiment applies also here. The narrowed tube bottom provides the advantage, however, that less dead volume of a liquid may rest inside the sample tube 1 after aspiration of the liquid with a liquid-handling apparatus.

FIG. 5 shows a longitudinal section of a sample tube with a narrowed, three-part bottom portion, integrated carrier walls, and integrated identification according to a fourth embodiment. All what has been said about the third embodiment applies also here. Like in the fourth embodiment also here, the narrowed tube bottom provides the advantage that less dead volume of a liquid may residue inside the sample tube 1 after aspiration of the liquid with a liquid-handling apparatus. The carrier walls 12 provide the two-component plastic sheet 10, which consists of the opaque material 7 of the identification portion 6 and the transparent cover layer 8 with the laser sensitive filler, with a guard against scratching the lower surface of the transparent cover layer 8. In addition, the carrier walls 12 define a large footprint of the sample tube 1, thus maximizing its ability to safely stand upright.

Also this fifth embodiment of the sample tube 1 according to the invention comprises different plastic components including one that provides the sample tube 1 with an enhanced fluid barrier (as has been specified in connection with the third embodiment). Also here, the opaque material 7 of the identification portion 6 and the transparent cover layer 8 with the laser sensitive filler together form a two-component plastic sheet 10, which may be produced by multi-component injection molding, laminating or back-molding. This two-component plastic sheet 10 preferably is attached (e.g. glued or welded) to the bottom 4 of the sample tube 1. In an alternative production process, the side walls 2 and the bottom 4 of the sample tube 1 are back-molded (preferably PURELL HP 371 P nature) to a rear side 11 of the opaque material 7 of the two-component plastic sheet 10. Preferably, in order to safely seal the sample in the sample tube 1 from the surrounding atmosphere, a seal film or sealing foil 21 (as shown) is applied to the border of the side walls 2 at the top opening 2 of the sample tube 1 by welding or gluing. This sealing film or foil 21 preferably is made of aluminum, a polymer or both. A polymer laminate on an aluminum foil is preferred, when welding of the seal foil (i.e. its polymer laminate) to the sample tube is to be applied.

The FIG. 6 shows a longitudinal section of a sample tube with a narrowed, three-part bottom portion, snap-on carrier walls and identification according to a sixth embodiment. Here, the two-component plastic sheet 10 is back-molded and/or injection molded around its periphery with carrier walls 12, preferably of polypropylene. Producing the carrier walls 12 from PURELL HP371P nature PP is especially preferred. The carrier walls 12 are accomplished to be snapped onto accordingly sized attachment parts 13 that are formed on the side walls 2 and/or the bottom 4 of the sample tube 1. These attachment parts 13 can comprise one single ring-like depression, which's ability to be gripped by a complementary ring-like elevation of the carrier walls 12 preferably is enhanced through a relief structure. This relief structure on the side walls 2 and/or the bottom 4 of the sample tube 1 protrudes into a ring-like depression in the snapped-on carrier walls 12. Comparable to the second embodiment, a protective bar 16 protrudes beyond the lower surface of the transparent cover layer 8, resulting in a recess 15 and providing the transparent cover layer 8 with a scratch protection. It is preferred that the gap between the rear side 11 of the opaque material 7 and the flat downside of the bottom is minimized and/or filled with an adhesive if a non-removable attachment of the carrier walls 12 and—more important—the identification portion 6 is desired.

Unlike in the previously described embodiments, the identification for a particular sample tube 1 according to a sixth embodiment can be produced independently from mass production of sample tubes and later snapped-on to an empty or already filled sample tune 1 of particular interest. Unlike the identification portions in the previously described five embodiments, where a simple univocal code or numbering is sufficient and preferred, the identification portion 6 of a particular sample tube 1 according to a sixth embodiment can carry additional information, like e.g. a laboratory identification, branding, or logo. In addition, the carrier walls can be made of a colored polymer, the colors presenting additional possibilities for coding the sample tube 1. Accordingly, one color (such as red, green, yellow, blue etc.) can be given to a special batch of samples, the batch e.g. being designated to a distinct case, sample source, laboratory etc.

Departing from this presentation in FIG. 6, but not departing from the spirit of the present invention, the side walls 2 and/or the bottom 4 of the sample tube 1 can have attachment parts 13 in the form of a series of, preferably alternating and ring-like, depressions and elevations. Accordingly, the carrier walls 12 alternatively can have a series of complementary elevations and depressions (not shown).

In the FIG. 7, a longitudinal section of a sample tube with a narrowed, four-part bottom portion, snap-on carrier walls and identification with a protective layer according to a seventh embodiment is shown. Unlike in the sixth embodiment, where the carrier walls 12 could have been made from any polymer material, whether it is transparent, opaque or even colored, the carrier walls 12 in the seventh embodiment are preferred to be transparent. This is because a transparent protective layer 14 is molded together with the carrier walls 12. Thus, the two-component plastic sheet 10, which consists of the opaque material 7 of the identification portion 6 and the transparent cover layer 8 with the laser sensitive filler, is guarded or protected against scratching the lower surface of the transparent cover layer 8. The carrier walls 12 can additionally be provided with a protective bar 16, which creates a recess 15 on the surface of the transparent protective layer 14 (as shown in FIG. 7). The preferred material for injection molding the carrier walls 12 and the transparent protective layer 14 is polypropylene, PURELL HP371P nature being especially preferred. Preferably, in order to safely seal the sample in the sample tube 1 from the surrounding atmosphere, a seal film or sealing foil 21 (as shown) is applied to the border of the side walls 2 at the top opening 2 of the sample tube 1 by welding or gluing. This seal film or foil 21 preferably is made of aluminum, a polymer or both. A polymer laminate on an aluminum foil is preferred, when welding of the sealing foil (i.e. its polymer laminate) to the sample tube is to be applied.

Departing from this presentation in FIG. 7, but not departing from the spirit of the present invention, the protective bar 16 and thus the recess 15 could be dispensed with, rendering the sample tube 1 with a plane surface to stand on. The FIG. 8 shows a longitudinal section of a sample tube with a narrowed, three-part bottom portion, snap-on carrier walls with a Radio Frequency Identification (RFID) tag and identification according to an eighth embodiment. RFID tags are well known to comprise a semiconductor chip and a related antenna that are embedded in a polymer material. The RFID tag serves as the opaque material in this embodiment. Like in the seventh embodiment, the carrier walls 12 in this eights embodiment are preferred to be transparent. This is because the transparent cover layer 8 is molded together with the carrier walls 12. The carrier walls 12 can additionally be provided with a protective bar 16, which creates a recess 15 on the surface of the transparent protective layer 14 (as shown in FIG. 8). The preferred material for injection molding the carrier walls 12 and the transparent cover layer 8 is polypropylene, PURELL HP371P nature being especially preferred. As already specified for the second embodiment, an amount of about 0.5 to 5 wt % of the laser sensitive filler HP756197 LS is preferably added to the polypropylene of the carrier walls 12 and in particular to the transparent cover layer 8.

The RFID tag provides the sample tube 1 with particular information write-in storage and read-out possibilities. Writing and reading can be made without visual contact between the write/read device and the RFID tag, which enables fast exchange of information between the write/read device and large numbers of RFID tags. This exchange of information preferably is carried out sequentially by individually addressing every single RFID tag. Such storage and exchange of information can include personal patient data, laboratory process data etc. In addition, the information exchange with particular RFID tags attached to sample tubes 1 provides tracking of the sample tubes 1 the laboratory and even in complex laboratory systems. Individual information on the sample tubes ensures unequivocal labeling of patient samples. In addition, the RFID tag can comprise a colored polymer, the colors presenting additional possibilities for coding the sample tube 1. Accordingly, one color (such as red, green, yellow, blue etc.) can be given to a special batch of samples, the batch e.g. being designated to a distinct case, sample source, laboratory etc.

In FIG. 9, a longitudinal section of a sample tube with a narrowed, three-part bottom portion, molded-on carrier walls with an RFID tag and identification according to a ninth embodiment is shown. Departing from the eighth embodiment, where the RFID tag may be snapped onto the sample tube 1, the RFID tag is completely molded-in here:
In a first step of a preferred production method, the RFID tag is back-molded with the transparent cover layer 8 of polypropylene (PURELL HP371P nature being especially preferred). As already specified, an amount of about 0.5 to 5 wt % of the laser sensitive filler HP756197 LS is preferably added to the polypropylene of the transparent cover layer 8. It is preferred to form the carrier walls 12 to the transparent cover layer 8 within the same step of back-molding and thus, with the same material composition.
In a second step of the preferred production method, the RFID tag and the inside of the carrier walls 12 is preferably back-molded with the same polypropylene material (PURELL HP371P nature) as used in the first step. However, the addition of the laser sensitive filler can be dispensed with.

This will produce a transparent sample tube 1 with an opaque material 7 embedded therein. The opaque material 7 can be an RFID tag as described. Alternatively, the opaque material 7 can be made of a colored polymer, the colors presenting additional possibilities for coding the sample tube 1. Accordingly, one color (such as red, green, yellow, blue etc.) can be dedicated to a special batch of samples, the batch e.g. being designated to a distinct case, sample source, sample tube volume, laboratory etc. In addition, the sample tubes of the present invention can be sealed with cap 18 or a foil (see e.g. FIGS. 5 and 7) that is glued or welded to the sample tube 1 at least in the region of or to the upper edge of the side walls 3.

In another alternative sample tube 1, the opaque material 7 of the identification portion 6 is selected from a group that comprises a colored sheet of plastic, or paper, or metal and a painted or sprayed layer. This opaque material 7 being over-molded with the transparent cover layer 8, preferably of polypropylene (preferably PURELL HP371P nature) with the laser sensitive filler (preferably 0.5-5 wt % of HP755197 LS).

The FIG. 10 shows a longitudinal section of a sample tube with a flat, three-part bottom structure and integrated identification according to a tenth embodiment. Departing from the second embodiment, where a two component bottom structure is shown, this tenth embodiment is characterized by a three component bottom structure. This three component bottom structure comprises the bottom 4 of the sample tube 1, an opaque material 7, and a transparent layer 8. A preferred production method for this sample tube 1 comprises:
A first step, in which the side walls 3, the bottom 4, and the carrier walls 12 are molded from a transparent polypropylene (PURELL HP371P nature being especially preferred).
A second step, in which the opaque material 7 that is selected from a group which comprises a colored sheet of plastic, paper, or metal and a painted or sprayed layer, is applied to the flat downside 5 of the bottom 4.

A third step, in which the opaque material 7 is over-molded with the transparent cover layer 8 of polypropylene (PURELL HP371P nature being especially preferred); the transparent polypropylene preferably containing an amount of about 0.5 to 5 wt % of the laser sensitive filler HP756197 LS.

This will produce a transparent sample tube 1 with an opaque material 7 embedded therein. The opaque material 7 can be an RFID tag as earlier described. Alternatively, the opaque material 7 can be made of a colored polymer, the colors presenting additional possibilities for coding the sample tube 1. Accordingly, one color (such as red, green, yellow, blue etc.) can be dedicated to a special batch of samples, the batch e.g. being designated to a distinct case, sample source, sample tube volume, laboratory etc.

The tenth embodiment preferably comprises protective bars 16 that are located in the periphery of the bottom 4 and that protrude over the lower surface of the transparent cover layer 8. These protective bars can be accomplished as a closed ring structure or as a number of bars that are separated by depressions (not shown). In any case, these protective bar 16 or bars provide the transparent cover layer 8 with a protection against scratches in its surface. As an alternative protection of the surface of the transparent cover layer 8, the recess 15 between the protective bars 16 can be filled (e.g. by over-molding) with a transparent protective layer 14 (see dashed line in FIG. 10) of polypropylene, preferably PURELL HP371P nature. In addition, the sample tubes of the present invention can be sealed with cap 18 or a metal sheet, preferably of aluminum that is glued or welded at least in the region of or to the upper edge of the side walls 3.

In the FIG. 11, a longitudinal section of a sample tube with a narrowed, four-part bottom portion, snap-on carrier walls with an RFID tag and identification according to an eleventh embodiment is shown. This embodiment is similar like the tenths embodiment; however, it has a narrowed bottom portion and the identification portion 6 located on snap-on carrier walls 12. Actually, the opaque material 7 can be a colored RFID tag, a colored polymer, or a colored metal plate.

These colors as well as the RFID tag present additional possibilities for coding the sample tube 1 as already described. Preferably, the opaque material 7 is over-molded with the transparent cover layer 8 and back-molded with a back-molded portion 19, to which the carrier walls 12 are molded.

Here (similar as in all other embodiments), only the opaque material 7 and the transparent cover layer 8 are decisive for the contrast of the code information burned into the transparent cover layer 8. Thus, all other parts of the sample tube 1 that do not cover the identification portion 6 can be of any polymer material. For example, the side walls 3, the bottom 4, and the back-molded portion 19 with the carrier walls 12 are can be of the same polypropylene material. This polypropylene preferably is PURELL HP371P nature. Alternatively, the back-molded portion 19 with the carrier walls 12 can be of a different material, such as PURELL HP371P with any desired colorant material to provide a simple color coding for the sample tubes 1. In another alternative variant, also the side walls 3 and the bottom 4 can be of any desired material, such as PURELL HP371P with any desired colorant material to provide a combined color coding for the sample tubes 1.

FIG. 12 shows a longitudinal section of a sample tube with a narrowed, five-part bottom portion, snap-on carrier walls with an RFID tag and identification according to a twelfth embodiment. This embodiment is similar like the eleventh embodiment; however, the identification portion 6 is over-molded with a transparent protective layer as an over-molded portion 20. Again, the opaque material 7 can be a colored RFID tag, a colored polymer, or a colored metal plate like in the eleventh embodiment. These colors as well as the RFID tag present additional possibilities for coding the sample tube 1 as already described. Preferably, the opaque material 7 is over-molded with the transparent cover layer 8 and back-molded with a back-molded portion 19, to which the carrier walls 12 are molded. For the back-molded portion 19 and for the over-molded portion 20 as well as for the carrier walls 12, the same transparent material (preferably PURELL HP371P nature) is used. This provides a transparent envelope to the identification portion 6. Like in the previous embodiment, the side walls 3 and the bottom 4 of the sample tube 1 can be made of a polypropylene with or without colorants. It is expressly pointed out that using a polypropylene as the polymer material in all parts of the sample tube 1 according to the invention is preferred. This selection is particularly useful for recycling of the single polymer material of these disposable sample tubes that are produced in large numbers. However, if special qualities or attributes are required for parts of the sample tube 1, those parts could be made of any other polymer material or even metal.

The sample tube 1, according to the invention and irrespective of any particular embodiment, preferably is accomplished to comprise a cap 18 that is screwed-on (see e.g. FIG. 10), screwed-in (see e.g. FIG. 2), pushed-on (see FIG. 3) or pushed-in (see e.g. FIG. 9). It is especially preferred that the sample tubes 1 are accomplished as microtubes that fit into a compartment of a rack for 24, 96, 384, or 1536 of such microtubes. Such a rack preferably has the dimensions of a standard microplate according to ANSI/SBS standards. The most preferred overall tube shape is cylindrical; however, slight deviation of the cylindrical shape can be allowed. Alternatively, in order to safely seal the sample in the sample tube 1 from the surrounding atmosphere, a seal film or seal foil 21 (as shown in the FIGS. 5 and 7) is applied to the border of the side walls 2 at the top opening 2 of the sample tube 1, preferably by welding or gluing. This sealing film or foil 21 preferably is made of aluminum, a polymer or both. A polymer laminate on an aluminum foil is preferred, when welding of the aluminum seal foil (i.e. its polymer laminate) to the sample tube is to be applied.

Deviating form the figures shown, the sample tube 1 according to the invention can be concavely shaped inside so that the bottom 4 merges into the side walls 3 in a curved manner.

As it can be seen from the presented set of embodiments, the material combination for the sample tube according to the invention can be chosen such that the tube side walls 3 and the bottom 4 are of one preferred material (e.g. PURELL HP371P nature with the laser sensitive filler HP755197 LS) that does provide the irradiated area 9, i.e. the identification code with a contrasting color (see FIGS. 1 and 2). If another material is chosen such as e.g. PURELL HP371P nature, an additional opaque material 7 is needed to provide the irradiated area 9, i.e. the identification code with a contrasting color (see FIGS. 3 to 12).

It will be of advantage to use flanges or fins (not shown), which preferably extend from the tube side walls 3 in order to prevent the sample tube 1 from being turned around its axis during one of the operations of screwing-in, screwing-on or during unscrewing a cap 18. Such fins or flanges preferable engage within grooves inside of the compartments of a rack for storing the sample tubes 1. The shape and distribution of these grooves preferably is adapted to the shape and distribution of the flanges or fins. In addition, retention means in the compartments of the rack are preferred as well in order to hold the sample tube 1 in the rack during withdrawal of a pushed-in or pushed-on cap. Such retention means (e.g. springs, latches, or hooks) preferably engage with respective depressions on or in the sample tubes 1 (not shown). In addition, such retention means also prevent the tubes from unintentionally falling out of the rack's compartments.

The inventors provided a broad range of different embodiments of the sample tube 1 according to the present invention. The same reference numbers refer to the same or at least similar features of the different embodiments even if they are not specifically addressed by the specification in each case. It is expressly noted here, that any combinations of features shown or described with respect to one or more of these embodiments also belong to the scope of the present invention. Thus, each tube shown in the attached drawings or described in the specification can e.g. be equipped with or without an intermediate polyamide barrier layer 17 and with or without a closing cap 18 or a sealing foil 21, independently on the type of the identification that is provided in the bottom portion of the sample tube 1.

### REFERENCE NUMERALS

1 sample tube

2 top opening

3 side walls

4 bottom

5 flat downside of the bottom

6 identification portion

7 opaque material

8 transparent cover layer

9 irradiated area

10 two-component plastic sheet

11 rear side of the opaque material of the two-component plastic sheet

12 carrier walls

13 attachment parts

14 transparent protective layer

15 recess

16 protective bar

17 intermediate polyamide barrier layer

18 cap, screwed-on or pushed-on, screwed-in or pushed-in

19 back-molded portion

20 over-molded portion

21 seal film, sealing foil

1. A sample tube comprising:
an elongated body having side walls defining a top opening;
a closed bottom formed at the lower end of the side walls, the bottom comprising an essentially flat downside;
an identification portion located at the bottom side, the identification portion comprising an opaque material with a first color and a transparent cover layer, wherein the transparent cover layer comprises a laser-sensitive filler that, upon irradiation with a laser marking beam, turns an irradiated area of the transparent cover layer into an opaque area with a second color that is contrasting from the first color.

2. The sample tube of claim 1, wherein the irradiated area is part of an identification marking which is selected from a group consisting of a linear 1-D barcode, a circular 1-D barcode, and a 2-D barcode.

3. The sample tube of claim 1, wherein the opaque material, the side walls, and the bottom are all formed from a material exhibiting a white or milky white first color, wherein the second color is a dark color selected from a group comprising grey, red, blue, green, and black.

4. The sample tube of claim 3, wherein the side walls and bottom are formed as an integral injection molded body of polypropylene.

5. The sample tube of claim 1, wherein the opaque material is formed from a different material than the side walls and the bottom, wherein the opaque layer has a first bright color that is selected from a group consisting of white, milky white, grey, red, blue, green, yellow, and orange, wherein the second color is a dark color selected from a group consisting of grey, red, blue, green and black.

6. The sample tube of claim 5, wherein the opaque layer and the transparent cover layer with the laser sensitive filler together form a two-component plastic sheet.

7. The sample tube of claim 1, wherein the opaque material comprises a radiofrequency identification (RFID) tag.

8. The sample tube of claim 6, wherein the two-component plastic sheet is attached to the bottom of the sample tube.

9. The sample tube of claim 6, wherein the side walls and the bottom are back-molded to an upper surface of the opaque layer of the two-component plastic sheet.

10. The sample tube of claim 6, wherein the two-component plastic sheet is back-molded or injection molded around its periphery with carrier walls that are adapted to be snapped onto corresponding attachment parts that are formed on the side walls (2) and/or the bottom (4).

11. The sample tube of claim 1, wherein the transparent cover layer is made of polypropylene comprising the laser-sensitive filler.

12. The sample tube of claim 5, wherein the opaque layer is selected from a group consisting of a colored sheet of plastic, a colored sheet of paper, a colored sheet of metal, a painted layer and a sprayed layer, wherein the opaque layer is over-molded with the transparent cover layer.

13. The sample tube of claim 1, wherein the transparent cover layer is over-molded with a transparent protective layer.

14. The sample tube of claim 10, wherein the transparent cover layer is disposed within a recess which is overlapped by a protective bar that is a part of one of the side walls, the bottom and the carrier walls.

15. The sample tube of claim 1, wherein the side walls and the bottom comprise different plastic components including one that provides the sample tube with an enhanced fluid barrier.

16. The sample tube of claim 15, wherein the side walls and the bottom comprise two layers of polypropylene and an intermediate polyamide barrier layer in-between.

17. The sample tube of claim 16, wherein the intermediate polyamide barrier layer is made of a crystalline polyamide resin or an amorphous nylon copolymer.

18. The sample tube of claim 1, wherein the elongated body is substantially cylindrical in shape.

19. The sample tube of claim 1, wherein the sample tube is a microtube adapted to fit into a compartment of a rack for 24, 96, 384, or 1536 of such microtubes.

20. The sample tube of claim 1, further comprising a cap that is adapted to be releasably attached at the top opening by screwing or press-fit.

21. The sample tube of claim 1, further comprising a sealing foil or film attached over the top opening of the sample tube by gluing or welding.
